(19) United States
(12) Patent Application Publication
(10) Pub. No.: US 2004/0173321 A1
(43) Pub. Date: Sep. 9, 2004

(54) Device for bonding substrates

(76) Inventors: Stephan Leonhardt, Bretten (DE); Ilhan Guclo, Bretten (DE); Roland Wagner, Bretten (DE)

Correspondence Address: Robert W Becker & Associates, Suite B, 707 Highway 66 East, Tijeras, NM, 87059, US

(21) Appl. No.: 10/477,450

(22) PCT Filed: May 2, 2002
(86) PCT No.: PCT/EP02/04780

(30) Foreign Application Priority Data
May 10, 2001 (DE) 101226683

(51) Int. Cl. B32B 31/00

(52) U.S. Cl. 156/556

(57) ABSTRACT

In order to ensure synchronous rotation of two substrates during bonding in a simple and economical manner, the invention provides a device for bonding two substrates having one inner hole to a substrate disc. Said device comprises a first rotating holding device (55) to hold the first substrate, a second rotating holding device (84) to hold the second substrate (84) and a drive mechanism for rotating one of the holding devices, wherein the second holding device is coupled to a rotating shaft (72) in a rotationally fixed manner (72), said shaft having a centering part (20) engaging in the inner hole of at least the second substrate while the second holding device can be moved along the axis of rotation of the shaft and thereupon.

The present invention relates to an apparatus for bonding or gluing together two substrates, which have an inner hole, to form a substrate disk, with a first holding device for holding the first substrate, a second rotatable device for holding the second substrate, and a drive means for rotating at least one of the holding devices.

Such an apparatus for joining disks together to form a CD or DVD is known, for example, from U.S. Pat. No. 4,877,475. During a rotation of the substrate disks, during which an adhesive material is uniformly distributed between them, they must be rotated synchronously and in a centered manner in order to ensure a proper joining together. With the known method, the synchronization is achieved via a positive connection between the substrates. While the lower substrate rests upon a rotatable support and is rotated therewith, the upper substrate is pressed so strongly against the lower substrate that it is rotated along with the lower substrate. The pressing together of the two substrates is effected by an axial movement of the second holding device, which holds the upper substrate. The axial movement of the holding device is effected via a linear carriage that is disposed laterally relative to an axis of rotation of the second holding device.

During the pressing together of the two substrates, it can happen that they are not precisely centered relative to one another, thus adversely affecting a proper joining together.

Proceeding from the known apparatus, it is therefore an object of the present invention to provide an apparatus for bonding substrates that in a straightforward and economical manner ensures a centered rotation of both substrates during the bonding process.

Pursuant to the invention, this object is realized with an apparatus of the aforementioned type in that the second holding device is fixedly coupled to a rotatable shaft with respect to a rotation thereof that is provided with a centering member that engages in the inner hole of at least the second substrate, and is displaceable along the axis of rotation of the shaft thereupon. As a result of these features, there is achieved a centering of at least the second substrate relative to the second holding device and hence also to the shaft. By the movement of the holding device on the shaft there is also ensured that during an axial movement of the second holding device the substrate remains in the centered position.

Pursuant to a particularly preferred embodiment of the invention, the axis of rotation of the first holding device coincides with the axis of rotation of the shaft. This ensures a uniform and centered rotation of the two substrates about a common axis of rotation during the bonding or joining together. In this connection, the shaft is preferably freely rotatably received in a carrier in order to be able to be freely rotated without its own drive means. For the loading and unloading of the substrates or the substrate disks, the shaft is preferably movable along its axis of rotation along with the carrier. In so doing, the second holding device is preferably movable together with the shaft along its axis of rotation.

In one embodiment of the invention, a centering pin is provided that is fixedly connected to the first holding device with respect to a rotation thereof and that is introducible into the inner hole of at least the first substrate in order to center it. The centering part is advantageously formed on the shaft as an engagement member that can be brought into engagement with the centering pin. In so doing, the rotational movement of one of the two holding devices can easily be transferred to the other holding device and to the substrate held thereon. As a consequence of this transfer of the rotational movement between the centering pin and the engagement member there results at every point in time a synchronous rotation of the two substrates during the bonding. In addition, the interval between the substrates and the point in time of the bonding can be freely selected, since the rotational movement is not transferred via a contact of the substrates.

Pursuant to a particularly preferred embodiment of the invention, the centering pin and the engagement member have complementary structures for a positive engagement, so that the transfer of the rotational movement is ensured without the application of a large axial force between the centering pin and the engagement member. For a straightforward design of the complementary structures they preferably include teeth on the centering pin and on the engagement member. To provide an easy mating of the teeth in the axial direction, and a self-centering function, each of the teeth has a tooth flank that extends essentially parallel to the axial direction of the centering pin, as well as a tooth flank that is inclined relative thereto. In this connection, the tooth flank on the centering pin that extends parallel to the axial direction preferably faces in the direction of rotation in order to provide a good transfer of force from the centering pin to the engagement member. As the teeth come into engagement they preferably effect a rotational orientation between the centering pin and the engagement member.

For a straightforward construction of the inventive apparatus, the centering pin is preferably stationary with respect to its location in space, so that only the engagement member need be moved toward and away from the centering pin. The engagement member is preferably movable axially toward and away from the centering pin, which enables a particularly simple guidance for the engagement member and a particularly simple mating of the engagement member with the centering pin. The centering pin and the engagement member preferably have the same periphery, thereby forming a uniform and continuous centering surface for the two substrates. In this connection, the engagement member is preferably provided as a centering pin for the inner hole of the second substrate.

In order to reliably hold the substrates during the rotation, at least one of the holding devices is provided with at least one vacuum suction device. For a good and uniform holding of the substrates, the vacuum suction device preferably has a ring with a plurality of suction openings.

The invention will be described subsequently with the aid of a preferred embodiment and with reference to the drawings; the drawings show:

FIG. 1 a perspective view of a centering pin pursuant to the present invention;

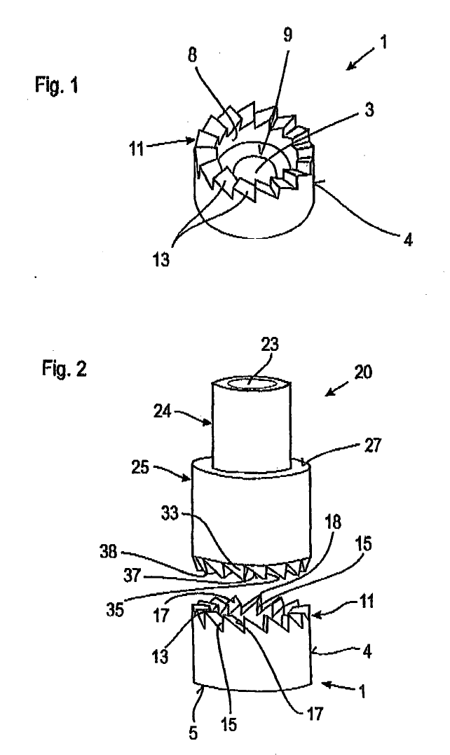

FIG. 2 a side view onto a centering pin and an engagement member of the present invention; and

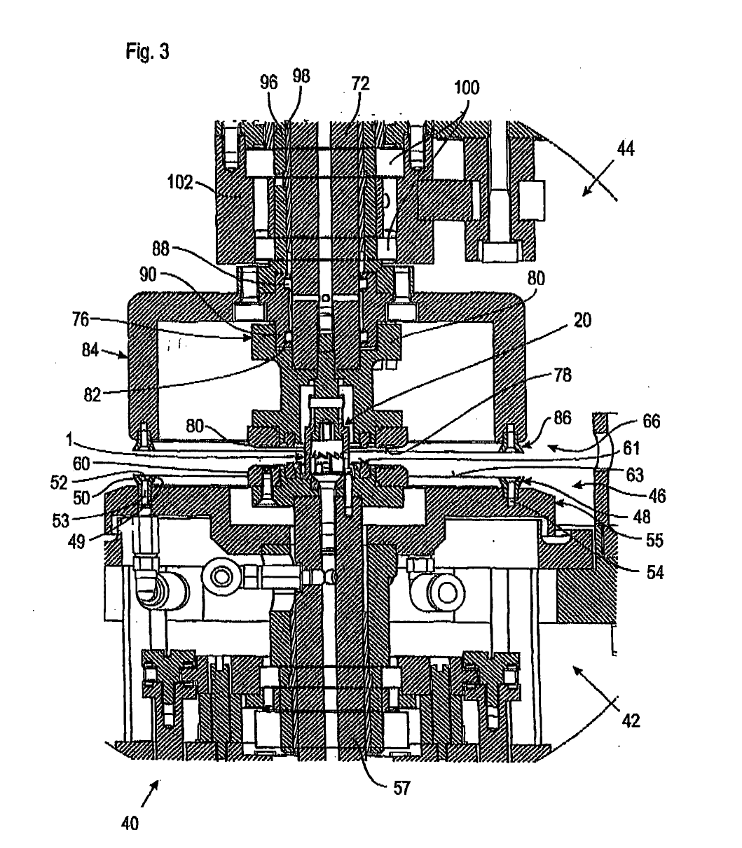

FIG. 3 a schematic partial cross-sectional view through an apparatus for the bonding of substrates pursuant to the present invention.

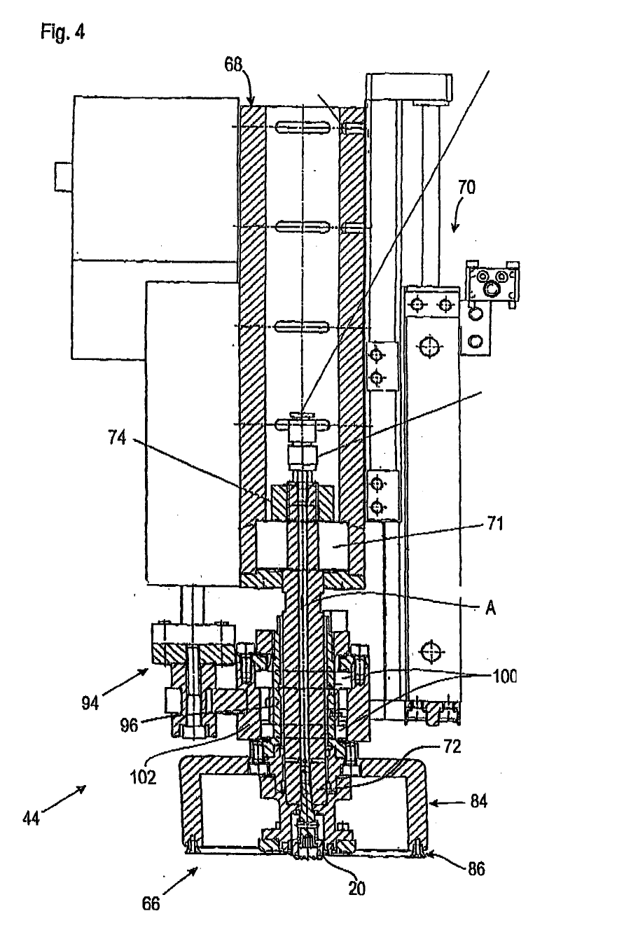

FIG. 4 a schematic cross-sectional view through an upper portion of the apparatus of FIG. 3.

FIG. 1 shows a perspective view of a centering pin 1 pursuant to a preferred embodiment of the present invention. The centering pin is described in greater detail in the application entitled “Apparatus for Bonding Substrates”, which originates from the same applicant and was filed on the same day as the present application, and which is made the subject matter of the present application in order to avoid repetition. The centering pin 1 has a circular cylindrical shape with a central opening 3 and a peripheral surface 4 that serves for guiding and centering substrates that have an inner hole.

The centering pin 1 has a planar underside 5. Provided in an upwardly directed portion of the centering pin 1 is a circular recess 8 having a diameter that is greater than the diameter of the central opening 3. By means of this recess 8, there is formed an upwardly directed shoulder 9 that extends between the central opening 3 and a wall portion 11 of the centering pin 1. On one side, i.e. upwardly directed in the axial direction of the cylindrical centering pin 1, the wall portion 11 has a toothed contour with a plurality of teeth 13. As can be best recognized in FIG. 2, the teeth 13 each have a tooth flank or side 15, which extends essentially parallel to the axial direction of the centering pin, as well as a tooth flank or side 17 that is inclined thereto; the tooth flanks respectively meet at an apex 18.

In FIG. 2, in addition to the centering pin 1, there is also shown an engagement member 20 that is disposed thereabove. The engagement member 20 has a circular cylindrical shape with a central opening 23. The engagement member 20 has an upper portion 24 as well as a lower portion 25. The upper portion 24 has a smaller peripheral dimension than does the lower portion 25, so that a shoulder 27 is formed between the two portions. The peripheral dimension of the lower portion 25 corresponds to the peripheral dimension of the centering pin 1. Disposed on the downwardly directed end of the lower portion 25 is a row of teeth that faces in the axial direction of the engagement member 20 and is provided with a plurality of teeth 33. The teeth 33 are complementary to the teeth 13 on the centering pin 1, and they each also have a tooth flank or side 35, which extends parallel to the axial direction of the engagement member, as well as a tooth flank or side 37 that is inclined thereto; the tooth flanks meet at an apex 38 of the teeth 33.

If the centering pin 1 and the engagement member 20 are moved axially toward one another, the inclined tooth flanks 17 and 37 of the complementary teeth 13 and 33 respectively slide along one another in order to achieve a rotational alignment between the centering pin 1 and the engagement member 20. Furthermore, due to the shape of the teeth 13 and 33, a centering of the centering pin 1 relative to the engagement member 20 is achieved. In the state where the centering pin 1 and the engagement member 20 are moved axially together, they form an essentially smooth peripheral surface.

As previously mentioned, the centering pin 1 can be connected to a rotary shaft of a rotational mechanism, as a result of which it can be actively rotated about its longitudinal central axis. Those tooth flanks that extend parallel to the axial direction of the centering pin face the direction of rotation, so that upon rotation of the centering pin 1 they come into positive engagement with the tooth flanks 35 that extend parallel to the axial direction of the engagement member 20, and thus enable a good transfer of force between the centering pin 1 and the engagement member 20. Of course, the engagement member 20 can also alternatively be connected to a driven rotary shaft, whereby then those tooth flanks that extend parallel to the axial direction of the centering pin face in the direction of rotation.

FIG. 3 shows a schematic cross-sectional view of an apparatus 40 for the bonding or gluing together of two substrates that have an inner hole and that for simplification of the illustration in FIG. 3 have been omitted. The apparatus 40 has a lower portion 42 and an upper portion 44, which in FIG. 3 are respectively illustrated only partially. The lower portion 42 has a centering and holding device 46 that is provided with the centering pin 1. The centering and holding device 46 is furthermore provided with a vacuum gripper in the form of a vacuum ring 48. The vacuum ring 48 has a circular, inwardly disposed sealing lip 49 as well as a circular outwardly disposed sealing lip 50, which between them form an annular space 52. The space 52 communicates via a plurality of vacuum openings 53 with an annular space 54 in a carrier 55. The annular space 54 communicates via a suitable supply line with a vacuum source, such as, for example, a pump. The carrier 55, which carries the vacuum ring 48, is fixedly connected with a rotary shaft 57 of the lower portion 42 and is rotatable therewith. The rotary shaft 57 is rotatable about its longitudinal axis via a suitable rotary device, such as, for example, an electric motor. The suction or vacuum ring 48 is concentric to the axis of rotation of the shaft 57. Although the carrier 55 is fixedly connected to the shaft 57 with respect to a rotation thereof, the shaft 57 is displaceable in the axial direction relative to the carrier 55, or the carrier 55 is displaceable relative to the shaft 57.

At its upper end, the rotary shaft 57 carries an attachment 60 that is fixedly connected to the shaft with respect to a rotation thereof and is axially displaceable with the shaft, and to which the centering pin 1 is also secured. The centering pin 1 and the attachment 60 are thus rotatable with the rotary shaft 57 and are displaceable therewith in the axial direction. The attachment 60 has a stepped upper side 61 that is movable upwardly beyond a plane 63 formed by the suction ring 48.

The function of this movement will be explained in greater detail subsequently during a description of the operation of the apparatus 40.

The upper portion 44, which is also illustrated in FIG. 4, has a holding and centering device 66 that contains the engagement member 20. The centering and holding device 66 is disposed above the centering and holding device 46 and is movable exclusively in the axial direction relative thereto, so that the two devices need only be moved toward and away from one another for loading and unloading substrates.

As can be best recognized in FIG. 4, the upper portion 44 has a carrier 68 that can be moved in the axial direction via a suitable carriage mechanism 70. A bearing 71 in the carrier 68 freely rotatably receives a shaft 72. By means of an appropriate securement element, such as, for example, a nut 74, the shaft 72 is fixed in the carrier 68 in such a way that although the shaft 72 can freely rotate about its axis of rotation A, it is fixed in the axial direction relative to the carrier 68. The shaft 72 is thus movable in the axial direction via the carriage mechanism 70. The direction of movement of the carriage mechanism 70 is exactly parallel to the axis of rotation of the shaft 72, so that during a movement of the carrier 68 along the axis of rotation A of the shaft 72 the shaft is moved.

At the free, lower end of the shaft 72 the engagement member 20 is mounted in such a way that it is fixedly connected to the shaft 72 with respect to a rotation thereof and can be moved along with it in the axial direction. The engagement member is furthermore mounted in such a way that its central axis coincides with the axis of rotation of the shaft 72.

Furthermore an attachment 76 is fixedly mounted on the free, lower end of the shaft 72 with respect to a rotation thereof, said attachment 76 having a downwardly directed annular abutment surface 78 that has rounded outer edges 80. The abutment surface 78 surrounds the engagement member 20 in an annular manner and is offset or recessed upwardly relative to the lowermost end of the engagement member.

On that end that is opposite the abutment surface 78, the attachment 76 is provided with a flange 80 that surrounds the shaft 72 in an annular manner and is spaced from the shaft 72 to form an annular space 82, as can be best recognized in FIG. 3.

The centering and holding device 66 on the upper portion 44 is provided with a bell-shaped carrier 84, on the downwardly facing end face of which is disposed a vacuum ring 86, which essentially has the same construction as the vacuum ring 48. Via suitable, non-illustrated means, the vacuum ring communicates with a vacuum source such as, for example, a pump.

The carrier 84 at least partially surrounds the shaft 72 and is fixedly connected to the shaft 72 with respect to a rotation thereof in a suitable manner, such as, for example, via a splined connection. However, via suitable bearing means 88 the carrier 84 is axially movable along the shaft 72, as will be explained in greater detail subsequently. A flange portion 90 of the carrier 84 extends into the annular space 82 that is formed between the shaft 72 and the flange 80 of the attachment 76. This ensures that particles that result due to friction between the shaft 72 and the bearings 88 are collected in the annular space 82 and do not pass onto the substrates that are to be joined together.

The carrier 84 is coupled with a linear movement mechanism 94, which, as will be described in greater detail subsequently, effects a movement of the carrier 84 along the shaft 72. The linear movement mechanism 94 is, in turn, secured to the carrier 68, so that it also follows a linear movement of the carrier 68. The carriage mechanism 70 has a much greater stroke range than does the linear movement mechanism 94, so that a rough positioning of the components of the upper portion 44 in the axial direction is effected via the carriage mechanism 70, and a fine movement exclusively of the carrier 84 is effected via the linear movement mechanism 94.

The coupling between the carrier 84 and the linear movement mechanism 94 is effected via a cylindrical sleeve 96 that is connected in a suitable manner with the carrier 84 and that is displaceable upon the shaft 72 via a cylindrical slide bearing 98. The sleeve 96 is surrounded by two bearings 100 in order to allow a rotational movement of the cylindrical sleeve 96 with the carrier 84 relative to a cylindrical receiving sleeve or casing 102, which is fixedly connected to the linear movement unit 94, with respect to a rotation thereof. An axial movement of the receiving casing 102 that is effected by the linear movement mechanism 94 is transferred to the sleeve 96 via appropriate, radially extending limits on the receiving casing 102 and/or the sleeve 96. The sleeve 96, in turn, transfers the axial movement to the carrier 84. This axial movement is guided by the shaft 72, so that the carrier 84, and in particular the vacuum ring 86, is moved in the axial direction in a precise alignment to the shaft 72, i.e. to the axis of rotation A thereof. Thus, the carrier 84, and in particular the vacuum ring 86, is also displaceable in the axial direction relative to the engagement member 20 and the attachment 76. The function of this axial displacement will be described in greater detail subsequently.

The operation of the apparatus 40 will now be explained in greater detail with reference to FIGS. 3 and 4.

The lower portion 42 and the upper portion 44 are first moved apart in the axial direction via the carriage mechanism 70, so that the centering and holding devices 46 and 66 can each receive a substrate that has an inner hole, such as, for example, a DVD half side. In so doing, the centering pin 1 extends into the inner hole of a first substrate, while the engagement member 20 extends into the inner hole of the other substrate. The substrates are held against the centering and holding devices 46 and 66 by the respective vacuum rings 48 and 86. The attachments 60 and 76 are in a retracted position in which they are not in contact with the substrates that are held against the vacuum rings 48 and 86. In this position, an adhesive can be applied to one of the substrates via a non-illustrated application device. The adhesive is preferably applied to the substrate in the form of a circular bead in the region of the central hole of the substrate. Alternatively, the adhesive (already prior to loading the apparatus) can be applied to one or both of the substrates.

The lower portion 42 and the upper portion 44 are subsequently moved toward one another in such a way that the teeth 13 on the centering pin 1, and the teeth 33 on the engagement member 20, inter-engage. Due to the shape of the 13, there is effected in so doing a rotational alignment between the centering pin 1 and the engagement member 20, as well as a centering of the two elements relative to one another. At this point in time, the substrates that are held by the vacuum rings 48 and 86 are held parallel to and at a small spacing from one another. The rotary shaft 57 is now rotated about its longitudinal axis via the drive means. In so doing, the carrier 55 with the vacuum ring 48, as well as the centering pin 1 and the attachment 60, are rotated along with the shaft. Due to the positive engagement between the centering pin 1 and the engagement member 20, the engagement member 20, and hence the rotatable shaft 72, the attachment 76, and the carrier 84, are also rotated. In this manner, the substrates, which at this point in time are held spaced from one another, are rotated synchronously with one another.

Due to a relative movement between the carrier 55 and the rotary shaft 57 in the axial direction thereof, the stepped upper side 61 of the attachment 60 is brought into contact with the substrate that is held on the vacuum ring 48. As a consequence of a continuing movement of the attachment 60 in such a way that the upper side 61 thereof is moved out beyond the plane 63 formed by the vacuum ring 48, the substrate, which continues to be held on the vacuum ring 48, bends upwardly in the central portion. As a result, the substrate initially comes into contact with the substrate disposed thereabove in the central portion. As a consequence of an appropriate relative movement between the vacuum ring 48 and the attachment 60, the substrate that is held on the vacuum ring 48 is now progressively brought together from the inside toward the outside with the substrate held thereabove, and is glued therewith.

Alternatively, or also in addition, there is effected an appropriate bending of the substrate that is held on the vacuum ring 86 by means of a movement of the carrier 84 along the shaft 72. As a result of a movement of the carrier 84 upwardly along the shaft 72, the substrate that is held on the vacuum ring 86 is initially moved against the abutment surface 78 of the attachment 76, and is then slightly bent about the rounded edges 80. This can effect a contact of the two substrates in their central portions. By means of a reverse movement of the carrier 84 along the shaft 72, the substrates can now be progressively brought together from the inside toward the outside and can be glued or bonded.

A bending of the lower substrate can be effected in parallel to the bending of the upper substrate, or it can also be entirely omitted.

As a result, a gluing or bonding of the two substrates without air bubbles between them is ensured.

During the above process, the two centering and holding devices 46, 66, and hence the substrates held thereon, are synchronously rotated with one another in a centered manner, which enables a good and homogeneous joining together.

Although the invention was described with the aid of a preferred embodiment of the invention, the invention is not limited to the concretely illustrated embodiment. For example, the two substrate holding and centering devices, instead of being oriented horizontally, can also be oriented vertically, thus effecting a joining together of the substrates in a vertical orientation. Instead of providing a rotational drive for the shaft 57, it would also be possible to provide a rotational drive for the shaft 72, whereby in this case the shaft 57 would be journalled in a freely rotatable manner.

1. Apparatus (40) for bonding two substrates, which have an inner hole, to form a substrate disk, with a first, rotatable holding device (48) for holding the first substrate, a second rotatable holding device (86) for holding the second substrate, and a drive means for rotating one of the holding devices (48, 86), characterized in that the second holding device (86) is fixedly coupled to a rotatable shaft (72) with respect to a rotation thereof that is provided with a centering member (20) that engages in the inner hole of at least the second substrate, and in that the second holding device (86) is axially displaceable along the axis of rotation (A) of the shaft (72) and thereupon:

2. Apparatus according to claim 1, characterized in that the axis of rotation of the first holding device (48) coincides with the axis of rotation (A) of the shaft (72).

3. Apparatus according to claim 1 or 2, characterized in that the shaft (72) is freely rotatably accommodated in a carrier (68).

4. Apparatus according to claim 2, characterized in that the shaft (72) is movable along its axis of rotation along with the carrier (68).

5. Apparatus according to claim 4, characterized in that the second holding device (86) is movable on the shaft (72) along its axis of rotation.

6. Apparatus according to one of the preceding claims, characterized by a centering pin (1) that is fixedly connected to the first holding device (86) with respect to a rotation thereof and that is introducible into the inner hole of at least the first substrate.

7. Apparatus according to claim 6, characterized in that the centering member on the shaft (72) is embodied as an engagement member (20) that can be brought into engagement with the centering pin (1).

8. Apparatus (40) according to claim 7, characterized in that the centering pin (1) and the engagement member (20) have complementary structures for a positive engagement.

9. Apparatus (40) according to claim 8, characterized in that the structures include teeth (13; 33) on the centering pin (1) and on the engagement member (20).

10. Apparatus (40) according to claim 9, characterized in that the teeth (13; 33) each have a tooth flank (15; 35) that extends essentially parallel to the axial direction of the centering pin (1) and of the engagement member (20) respectively, and a tooth flank (17; 37) that is inclined relative thereto.

11. Apparatus (40) according to claim 10, characterized in that the tooth flank (15) on the centering pin (1) that extends parallel to the axial direction faces in the direction of rotation.

12. Apparatus (40) according to one of the claims 9 to 11, characterized in that during the coming into engagement, the teeth (13, 33) effect a rotational orientation between centering pin (1) and engagement member (20).

13. Apparatus (40) according to one of the claims 6 to 12, characterized in that the centering pin (1) is stationary in the apparatus (40) with respect to its location therein.

14. Apparatus (40) according to one of the claims 7 to 13, characterized in that the engagement member (20) is provided as a centering pin for the inner hole of the second substrate.

15. Apparatus (40) according to one of the claims 7 to 14, characterized in that the centering pin (1) and the engagement member (20) have the same periphery.

16. Apparatus (40) according to one of the preceding claims, characterized in that at least one of the holding devices (48; 86) has at least one vacuum suction device.

17. Apparatus according to claim 16, characterized in that the vacuum suction device has a ring (48; 86) with a plurality of vacuum openings (53).
